(19) United States
(12) Patent Application Publication
(10) Pub. No.: US 2006/0143940 A1
(43) Pub. Date: Jul. 6, 2006

(54) System and method for curing and heat-setting a resin dye in a material

(76) Inventors: Carlos Yidi JR., Miami, FL (US); Rafael Cure, Miami, FL (US)

Correspondence Address: FELDMANGALE, P.A., MIAMI CENTER, 19TH FLOOR, 201 SOUTH BISCAYNE BOULEVARD, MIAMI, FL, 33131-4332, US

(21) Appl. No.: 11/084,373

(22) Filed: Mar. 18, 2005

Related U.S. Application Data
(60) Provisional application No. 60/636,570, filed on Dec. 16, 2004.

(51) Int. Cl. F26B 3/00; F26B 3/34

(52) U.S. Cl. 34/444; 34/245

(57) ABSTRACT

A system for curing dye at a material web includes a curing chamber defining an interior for receiving the web of material therein. An entrance connects the interior with the environment and receives the web therethrough. An exit connects the interior with the environment and transmits the web therethrough from the interior to the environment. A temperature sensor is disposed at the curing chamber and senses web temperature. A heating system heats air inside the chamber. An air transfer system circulates air in the interior of the chamber. The air transfer system and the heating system, when activated, heat the web in the interior to a substantially constant curing temperature. Preferably, the web is a web for clothing labels and the dye in each label is a resin dye indicating washing instructions and/or data of a garment on which a respective one of the labels is attached.

### CROSS-REFERENCE TO RELATED APPLICATION

This application claims the benefit under 35 U.S.C. § 119(e) of U.S. Provisional Application No. 60/636,570, filed Dec. 16, 2004, the complete disclosure of which is hereby incorporated by reference herein in its entirety.

### FIELD OF THE INVENTION

The present invention relates generally to printing material labels that, for example, are used to indicate washing instructions and variable data of a garment on which a label is attached.

### BACKGROUND OF THE INVENTION

The most prevalent use of labels made out of a woven material is for clothing items. Such labels having printed indicia including, for example, the manufacturer's name, the distributor's name, the retailer's name, fabric identification information, SKU information, barcodes, and/or cleaning instructions. Because labels are subject to repeated washing with chemicals, there is a need to have the printed indicia be very resistant to corrosive and abrasive environments.

One segment of the garment industry, industrial uniform manufacturers and laundry services, requires high quality, durable printed fabric labels, typically only available from large scale commercial printing houses, not from in-plant printing systems. Industrial uniforms are subjected to extremely corrosive and abrasive laundering conditions that destroy the legibility of ordinary fabric labels. Therefore, preprinted dyed labels, where the image is actually fixed into the fabric of the label, and preprinted labels with cured or thermoplastic overcoatings are required to maintain legibility. Industrial uniform manufacturers require print legibility for advertising purposes and to allow the garment user to maintain size integrity of his garments after each industrial laundering. If the garment size on the label becomes illegible, the garment cannot be classified properly according to size. Industrial uniform services have observed that unless label legibility is maintained, a high percentage of uniforms are lost, stolen, or misplaced during the laundering process. See, for example, U.S. Pat. No. 4,541,340 to Peart et al. (hereinafter “Peart”).

Another extremely corrosive and abrasive environment is the process for fading jean material, for example. This process can include stone washing, enzymatic washing, ecological washing, and double stone washing, to name a few.

In such extreme processes, it is common for the printed indicia to fade and/or smudge even before the customer has purchased the goods having the printed label. Smudging of the printed indicia is referred to in the art as “bleeding.” This term is used because the printed indicia on one side of the label can be seen as a shade from the opposite side of the label. Such characteristics are to be avoided because they prevent the reader from easily and clearly reading the printed indicia.

Various devices exist in the art of printing labels. One system and method is described in U.S. Pat. No. 6,698,958 to Emery et al. (hereinafter “Emery”). Emery discloses a machine that heats a sublimable dye to its sublimation temperature. At this temperature, the dye becomes a gas and, in such a state, is heat embedded into the material on which it was printed. When cooled, the sublimed dye bonds to the material. Peart indicates that the sublimable dye that is used in the ink composition can be any dyestuff or mixture of dyestuffs that vaporize or otherwise convert to a mobile phase at a temperature above about 140° C. (284° F.) and, preferably, between about 160° C. (320° F.) and about 205° C. (401° F.), at atmospheric pressure. Dyestuffs with sublimation temperatures below 140° C. can be used, but are not as suitable because of their tendency to resublime on washing or ironing, thereby lowering the fastness of the image below those desired in industry. Further description of sublimation and sublimating dyes may be found in Peart.

The Emery device is at least 18 inches wide to make room for the displacing heater assembly. The Emery device is not able to print fine lines or lettering. When such printing is attempted, the lines or lettering are blurry.

The prior art web printing devices use only radiating heat and do not heat with moving air.

Another kind of dye that is used in printing labels is a resin dye (or ink). Resin dyes are not designed to be heated past a given temperature. In particular, they are not to be heated to a sublimation temperature of the dye (approximately above 400° F. (205° C.)). Specifically, they are heated only to their melting temperature, which is less than 205° C. (400° F.). The Emery process and system cannot be used on non-sublimable dyes. In particular, it cannot be used with resin dyes.

Using the sublimation method according to Emery gives an upper limit to the detail in the lettering or design being printed. Emery also produces two-sided webs that have fabric bleeding.

Accordingly, it would be beneficial to provide a device and method for treating resin dyes in a way that increases resistance to wear, improves definition of the printed indicia, and eliminates bleeding of inks on one side from being seen from the other side.

### SUMMARY OF THE INVENTION

It is accordingly an object of the invention to provide a system and method for curing and heat-setting a resin dye in a material that overcome the hereinafore-mentioned disadvantages of the heretofore-known devices and methods of this general type and that allows one or both sides of a web of material to have resin dye thereon cured and heat-set with the force of air and heat combined and in which the resin dye remains with a high definition even when laundered industrially in an corrosive and abrasive environment.

With the foregoing and other objects in view, there is provided, in accordance with the invention, a system for curing dye at a material web, including a curing chamber defining an interior for receiving the web of material therein, an entrance connecting the interior with the environment and receiving the web therethrough in a first direction, and an exit connecting the interior with the environment and transmitting the web therethrough from the interior to the environment in a second direction, a temperature sensor disposed at the curing chamber for sensing a temperature of the web, a heating system disposed at the chamber and heating air inside the chamber and an air transfer system disposed at the chamber and circulating air in the interior of the chamber, the air transfer system and the heating system, when activated, heating the web in the interior to a substantially constant curing temperature.

In accordance with another feature of the invention, there are provided a first web-direction-changing device disposed at the chamber altering a movement direction of the web from the first direction to a third direction and a second web-direction-changing device disposed at the chamber altering a movement direction of the web from the third direction to a fourth direction.

In accordance with a further feature of the invention, there is provided a third web-direction-changing device disposed at the chamber altering a movement direction of the web from the third direction to the second direction.

In accordance with an added feature of the invention, there is provided a third web-direction-changing device disposed at the chamber for altering a movement direction of the web from the third direction to a fourth direction.

In accordance with an additional feature of the invention, the chamber has a bottom surface, the first direction is parallel to the bottom surface, the second direction is parallel to the bottom surface, the third direction is at an angle to the bottom surface, and the fourth direction is at an angle to the bottom surface.

In accordance with yet another feature of the invention, the first direction and the second direction are substantially parallel. In particular, the first direction and the second direction are collinear. The first and second directions can be substantially parallel to ground and the third and fourth directions can be substantially vertical.

In accordance with yet a further feature of the invention, the chamber has a bottom and a top, the entrance and the exit are at the bottom of the chamber, a web guide is disposed at the top of the chamber for guiding the web from the bottom upward in an approximately vertical direction entirely through the chamber and approximately reverse the course of the web downward in an approximately vertical direction entirely through the chamber to exit the chamber from the bottom, and the temperature sensor is disposed at the top of the chamber.

In accordance with yet an added feature of the invention, the temperature sensor is an infrared temperature sensor or any other temperature-measuring device.

In accordance with yet an additional feature of the invention, there is provided a second temperature sensor disposed at the exit and measuring a temperature of the web exiting the chamber.

In accordance with again another feature of the invention, the chamber has a door that, when opened, permits a user to access the web inside the chamber.

In accordance with again a further feature of the invention, there is provided a web cutter/stacker system disposed downstream of the chamber for cutting the web into individual labels and stacking the cut labels.

In accordance with again an added feature of the invention, the chamber has at least one air inlet side and the air transfer system is a blower directing environmental air into the air inlet side of the chamber in an air blowing direction. Preferably, the heating system is disposed between the web and the blower. The heating system can be disposed downstream of the blower in the air blowing direction.

In accordance with again an additional feature of the invention, the chamber has a top defining an opening allowing heat in the chamber to escape. The top has a chimney carrying away heated air from the chamber. The chamber has a roof pitched to place the chimney at an upper-most portion thereof. The chimney defines a window accommodating therein the temperature sensor and/or defines a temperature sensor position inside the chamber.

In accordance with still another feature of the invention, the heating system has a heater element and a heat shield disposed opposite the heater element on an opposite side of the web and reflecting heat back to the heating system and/or absorbing heat from the heating system to regulate temperature of air in the interior of the chamber.

In accordance with still a further feature of the invention, there is provided a second blowing system and a second heating system on a side of the web opposite the heating system and the blowing system.

In accordance with still an added feature of the invention, there is provided a controller programmed to detect changes in motion of the web. The controller has control and read lines connected to the temperature sensor, the heating system, the air transfer system, the web, and a web control system to transmit control signals thereto and read signals therefrom. The controller controls the heating and air transfer systems to maintain a temperature inside the chamber between approximately 200° F. and approximately 390° F.

In accordance with still an additional feature of the invention, the web is a web for clothing labels and the dye in each label indicates at least one of washing instructions and data of a garment on which a respective one of the labels is attached. The dye is resin ink printed on the web and the chamber, the heating system, and the air transfer system cure the resin ink on the web.

With the objects of the invention in view, there is also provided a system for curing dye at a material web, including a curing chamber defining an interior for receiving the web of material therein and having a top and a bottom, the bottom defining an entrance connecting the interior with the environment and receiving the web therethrough in an approximately vertical direction and an exit connecting the interior with the environment and transmitting the web therethrough from the interior to the environment in an approximately vertical direction, a temperature sensor disposed at the top of the chamber for sensing a temperature of the web, a heating system disposed at the chamber and heating air inside the chamber, an air transfer system disposed at the chamber and circulating air heated by the heating system in the interior of the chamber, the air transfer system and the heating system, when activated, heating the web in the interior to a substantially constant curing temperature, and the temperature sensor, the heating system, and the air transfer system being fixed in position relative to the chamber.

With the objects of the invention in view, there is also provided a method for curing dye at a material web, including the steps of providing a material web having a dye printed thereat, passing the web through a dye-curing chamber upwards in an approximately vertical direction, heating an interior of the chamber to a dye-curing temperature, measuring a temperature of the heated web at a top of the chamber, and passing the heated web back through the chamber downwards in an approximately vertical direction to cure the dye in the web. The measuring of the temperature inside the chamber can occur instead of or in addition to the measuring at the top of the chamber.

The present invention provides a high definition of the printed indicia while increasing the resistance to industrial laundry processes that are extremely corrosive and abrasive to the label.

The process of the present invention cures and heat sets one or both sides of a web of woven material that will be used to form a woven label and/or a printed label tape.

A resin dye/ink coming from a digital printer is cured and heat set on a woven label and/or a printed label tape in a non-contacting process that uses infrared heat and air flow in a heat curing chamber. When the resin ink is printed on the web, the printer only heats the resin to between approximately 85° C. (185° F.) and approximately 115° C. (240° F.).

The airflow device in the curing chamber is adjustable. Therefore, the airflow device can distribute the infrared heated air volume (measured in cubic feet per minute (CFM)) at any desired rate and, thereby, regulate temperature of the environment surrounding the web of woven material. By measuring the temperature at various locations with respect to the curing chamber, the temperature at which the web is exposed can be held substantially constant. For example, temperature can be measured at the web entry site, the web exit site, both sites, or a site anywhere in between.

To cure the web of material in the present invention, the web is fed into a vertical tower. The tower includes a variable forced air device that passes air heated by an infrared heater over and through the web. The web travels through the tower in a non-contacting manner. At a top side of the tower on the outside of the tower is an infrared temperature control sensor that measures the temperature of the web. The sensor sends data to a controller connected to the blower assembly and/or the infrared heater to maintain the desired curing and heat-setting temperature of between approximately 200° F. to approximately 390° F.), in particular, to approximately 240° F.

The blower assembly is configured to move the heat in all directions within the curing chamber and, therefore, air deflectors can be provided therein to cause random swirling of the heated airflow. Such swirling allows uniform heating of and through the weave of the material web.

The present invention ensures that the web is not overheated or damaged by, first, regulating the temperature at which the web is exposed, and, second, by controlling the blower and heater assemblies to enter into a fail-safe mode if, for any reason, the material web breaks, the system printer fails, the stacker fails, the cutter fails, and/or the inks supply is non-optimal. In the fail-safe mode, the controller causes the electrical heater to cool to a reduced safety level at temperature substantially below the curing temperature and the blower assembly to go into an increased blowing mode (in particular, full-speed blowing mode)—making the air at the curing temperature exit the curing chamber in a time frame that prevents damage to the non-moving web of material.

The reduced safety level is not so low to require a delay in the web movement until the curing chamber heats up to the curing temperature. Once the restart order arrives, the reaction time of the heater is quick enough to come back to the curing and heat-setting temperature within a few seconds, preferably, 2 to 5 seconds.

Use of the system and method according to the present invention achieves a definition of the indicia that is better than all prior art label-printing systems.

The web that is used in a preferred embodiment of the present invention has a minimal contraction in its weave construction due to the heat setting that is used. This makes the design tighter and increases the printed dot resolution and, therefore, increases the detail. The process of the present invention also makes the printed dye permanent in the width dimension of the web. Thus, the printed indicia does not spread or bleed.

The present invention also provides some very important advantages over the prior art.

First, the present invention reduces fumes, to the operator and to the environment.

Second, the present invention passes the web twice through the curing chamber.

Third, the air-forced infrared radiation creates a hot circulating flow that evenly distributes the curing temperature over the portion of the web in the curing chamber.

Fourth, the curing chamber has little or no moving parts. This is due to the fact that the heating elements are fixed in position (compare Emery) with regard to the web, the web input station, and the printer.

Fifth, the vertical tower configuration is compact in terms of floor space and creates a flow of heated air that exits the curing chamber naturally at a top thereof.

Sixth, the present invention substantially prevents bleeding of the ink. Each side of the web treated by the system and method of the present invention is printed with a resolution that allows easy reading without interference by the indicia printed on the opposite side.

Seventh, blowing air scrubs residues of ink that is not fully cured off of the material web. In other words, when any undesired residue or particles are on the web, the blowing air cleans the web before being cut into the individual labels. A process that merely uses proximity of a heat source(s) to sublime the dye, as performed in Emery, cannot achieve this advantage.

Eighth, blowing air softens the material that makes up the web of labels. Thus, after the labels are cut, the material is softer to the touch of a person than if the blowing air of the present invention was not applied to the label. One very important characteristic of fabric labels is that they be very soft. If the label is not soft, then the user will most likely cut the label from the garment, thereby removing the cleaning and/or other important information from the garment.

Other features that are considered as characteristic for the invention are set forth in the appended claims.

Although the invention is illustrated and described herein as embodied in a system and method for curing and heat-setting a resin dye in a material, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, diagrammatic cross-sectional view of a first embodiment of a web processing system according to the invention along a section of the web to be processed;

FIG. 2 is a plan view of the web processing system of FIG. 1;

FIG. 3 is a fragmentary side elevational view of a first embodiment of a web roller and a blower sub-system of the web processing system of FIG. 1;

FIG. 4 is a fragmentary side elevational view of a second embodiment of a web roller and a blower sub-system of the web processing system of FIG. 1;

FIG. 5 is a fragmentary side elevational view of a third embodiment of a web roller and a blower sub-system of the web processing system of FIG. 1;

FIG. 6 is a fragmentary, diagrammatic cross-sectional view of a second embodiment of a web processing system according to the invention along a section of the web to be processed;

FIG. 7 is a fragmentary, diagrammatic cross-sectional view of a third embodiment of a web processing system according to the invention along a section of the web to be processed;

FIG. 8 is a fragmentary, diagrammatic cross-sectional view of a fourth embodiment of a web processing system according to the invention along a section of the web to be processed;

FIG. 9 is a block circuit diagram of the control assembly of the web processing system according to the invention; and

FIG. 10 is a flow chart of one exemplary operating mode of the web processing system according to the invention.

### DESCRIPTION OF THE PREFERRED EMBODIMENTS

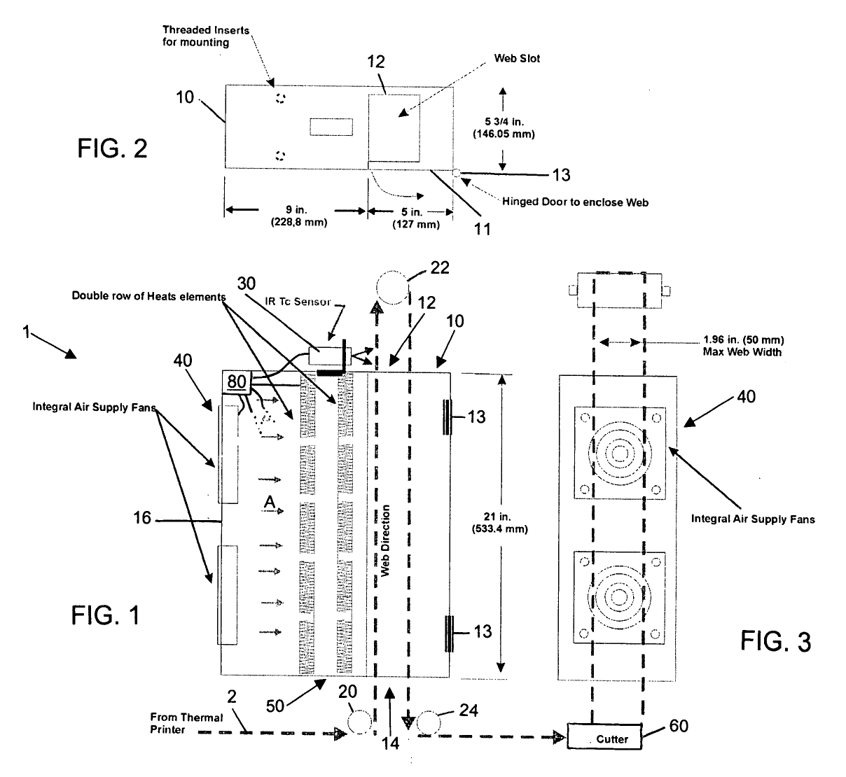

Referring now to the figures of the drawings in detail and first, particularly to FIG. 1 thereof, there is shown a diagrammatic illustration of a first embodiment of dye curing system 1 according to the invention.

FIG. 1 is a diagrammatic cross-section of the dye curing system 1 along the path of the material web 2. A curing chamber 10 houses the heating and air transfer components of the system 1. In the embodiment of FIG. 1, the web 2 travels around a first web direction changing device 20, enters the chamber 10 from the bottom, and travels upward in a substantially vertical direction entirely through the chamber 10. It is noted that, while the vertical direction is preferred, it is not required. The web 2 can be oriented in any manner in the chamber 10, whether at an angle, in a curve, or in a multiple recurve. However, the more time that the web 2 spends in the chamber 10 increases the likelihood of damage and/or burning. Accordingly, it is desirable to keep the web 2 in the chamber only for the minimum time needed for curing the resin dye and at a substantially constant curing temperature.

Next, the web 2 exits the top of the chamber 10. Travels around a second web direction-changing device 22 and enters the top of the chamber 10. At the point the web 2 exits the chamber 10, it is in an optimal position to determine whether or not the web 2 is at the optimal curing temperature. Therefore, a temperature sensor 30 is disposed at the first web exit opening 12 at the top of the chamber 10. Preferably, the temperature sensor 30 is an infrared temperature sensor.

After leaving the second device 22, the web 2 travels downward through the chamber 10 in a substantially vertical direction parallel to the upward traveling portion of the web 2 until a direction of the web 2 is changed by a third web direction-changing device 24. While not pictured in FIG. 1, a second, non-illustrated, temperature sensor 30 can be positioned to measure the temperature of the web 2 exiting the second web exit opening 14 at the bottom of the chamber 10.

In the preferred embodiment, the portion of the web 2 after (downstream of) the third device 24 travels substantially parallel to the portion of the web prior to (upstream of) the first device 20. Such a configuration is preferred because it allows the system 1 to be very compact. The compact size of the chamber 10 is illustrated in FIG. 2, for example. The chamber 10, housing the blower system 40, the heating system 50, and the path for moving the web 2 has a horizontal area of approximately 14.6 cm (5.75″) by approximately 35.6 cm (14″). The height of the chamber is approximately 53.3 cm (21″). This size is substantially smaller than prior art web treating devices, such as Emery. For access to the web 2 inside the chamber, a door 11 is provided on at least one side of the web 2. The door 11 opens upon hinges 13 attached to the chamber 10.

The web 2 is, then, ready to be cut into individual labels. Accordingly, a web cutter 60 is disposed downstream of the third device 24. Associated or integral with the cutter 60 is a stacker for stacking the cut labels in a configuration that can be easily transported, packaged, and shipped. The cutter/stacker 60 can be any conventional cutting and/or stacking system(s) and, therefore, is not described in further detail herein.

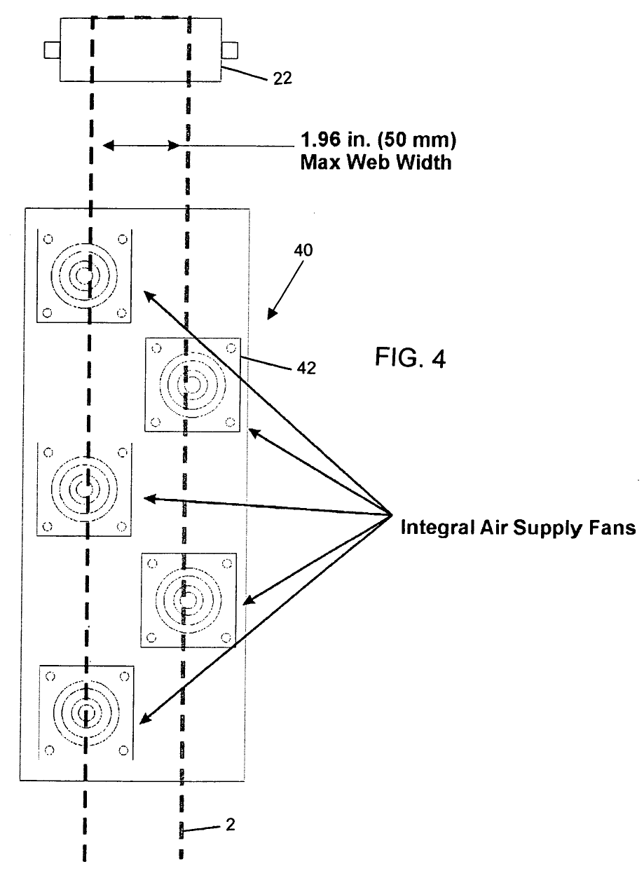

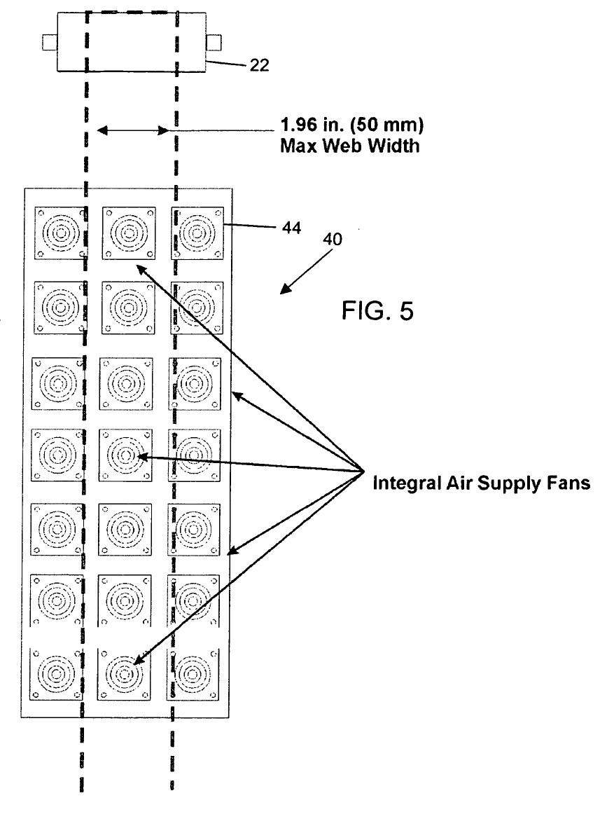

The blower system 40 blows environmental air into an air inlet side 16 of the chamber 10. The heating system 50 is located adjacent the web 2 between the web 2 and the blower system 40. The heating system 50 is, therefore, disposed downstream of the blower system 40 in the air blowing direction A. Because the heating system 50 is downstream of the blower system 40 in the air blowing direction A, the blower system 40 is not exposed to the elevated heating imparted onto and through the web 2. Therefore, the components of the blower system 40 need not be required to withstand the upper limits of temperature. This reduces the cost of the blower components. In the embodiment shown in FIG. 1, diagrammatic illustrations are provided to indicate the blowing system 40. This configuration is only exemplary. The blowing system 40 can include a series of fans disposed from the top of the chamber 10 to the bottom thereof. The fans need not be all the same size. Because fans are, typically, circular, gaps can appear between the fans. Therefore, as shown in FIGS. 3, 4, and 5, different sized fans 42, 44 can be distributed in any configuration and the different sized fans can be combined together. If one or more dispersing cones are provided on the downstream side of the blower system 40, then the blowing air can be made to impact the heating system 50 and the web 2 more evenly and/or with turbulence devices that cause random swirling behavior in the heated air.

As also shown in FIGS. 3 to 5, the web 2 has a given width. While the figure indicates that a maximum web width is approximately 5 cm (2″), the chamber 10 and the other components can be made larger to accommodate any size material web 2. For example, the embodiment shown in FIG. 3 illustrates a maximum width of standard sized labels for clothing garments.

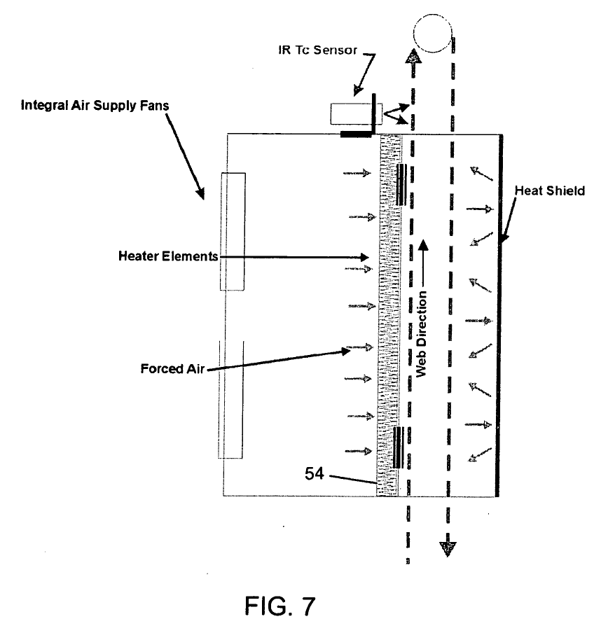

The heating system 50 is shown in FIG. 1 as a double row of a plurality of heating elements 52. This configuration is only exemplary. A preferred embodiment of the heating system 50 includes a heating device that evenly and uniformly heats the web 2 in the chamber 10. Such a configuration is shown in FIG. 7. The heater element 54 extends from the top of the chamber 10 to the bottom thereof. Forced air blows over the element 54 and, therefore, the web 2 is exposed to air having an approximately uniform temperature. While it is true that heat rises and, therefore, the top of the chamber 10 could be hotter than the bottom thereof, in a preferred embodiment, the chamber 10 is configured to not trap heat at the top thereof and, thereby, not allow the top portion of the web 2 in the chamber 10 to heat more than the bottom portion. Specifically, the first web exit opening 12 (see, e.g., FIG. 2) is sufficiently large to permit the heat inside the chamber 10 to exit in the manner of a chimney. Therefore, the heat imparting the web 2 in the chamber 10 is a constant flow (assuming the fans 40 are blowing at a constant speed during the curing process) and is a constant temperature (because only the heated air directly upstream of the web portion in the chamber 10 is heated—the remaining heated air that could unevenly heat the web 2 is carried away through the opening 12 before it has a chance to increase the temperature inside the chamber 10.

To aid in carrying away the heated air from the chamber 10, as shown in FIG. 7, a chimney 70 can be provided over or around the top opening 12 and/or the second device 22. To improve the function of the chimney 70, the roof of the chamber can be pitched to place the chimney 70 at the upper-most point of the roof. The chimney 70 can also have an opening or a window 72 for accommodating therein the temperature sensor 30. In such a configuration, the heated air can be safely carried away from the chamber 10, thus, minimizing the possibility of dangerous exposure to the heated air by a person operating the system 1. Of course, in colder environments, the excess heated air can be used for heating or pre-heating any external system.

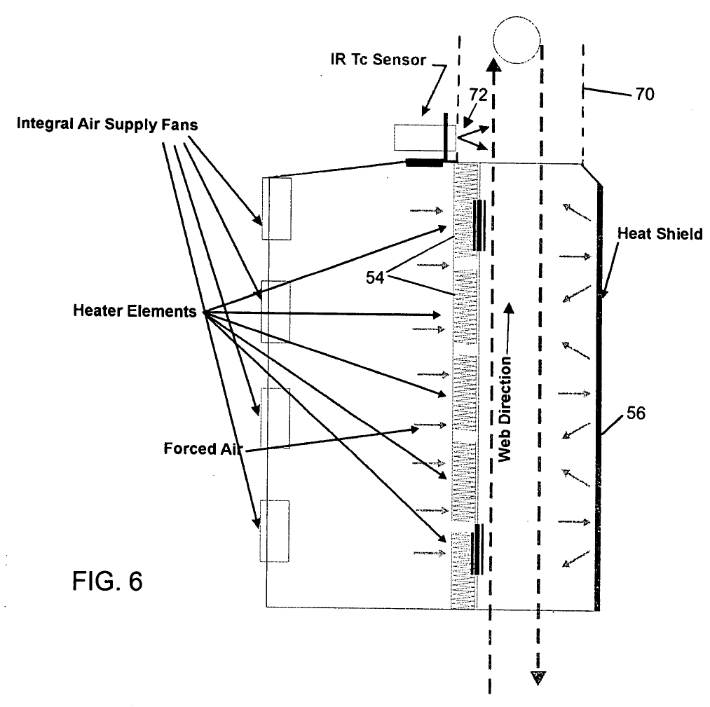

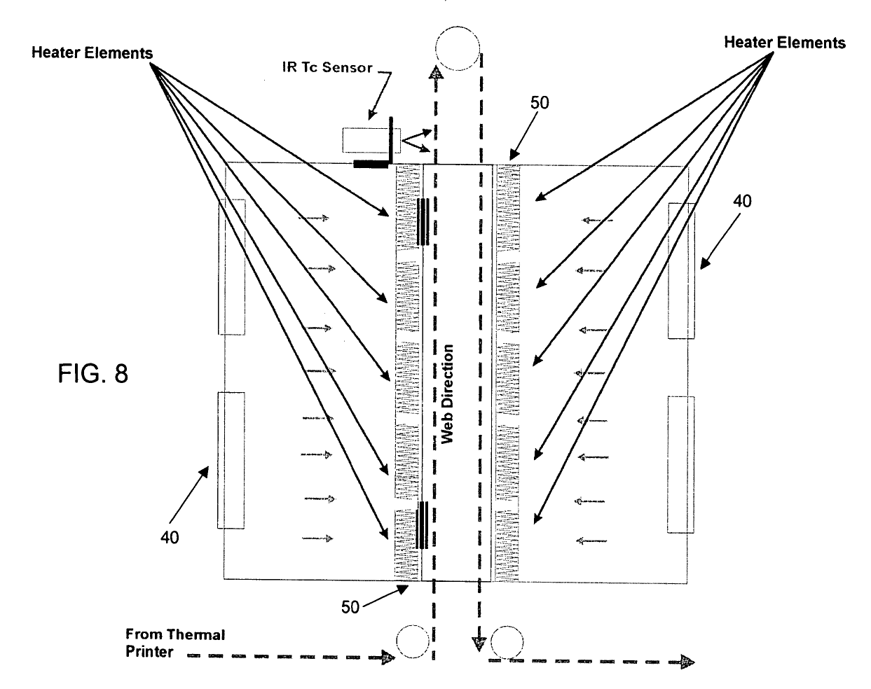

An improvement of the heating system 50 includes a heat shield 56 disposed opposite the heater element 54, as shown in FIGS. 6 and 7. This heat shield 56 can reflect the heat back to the downwardly moving second web section and/or absorb heat to assist in regulating the interior environment of the chamber 10. If the web 2 needs to be heated for a time that is longer than the time it takes for a point on the web 2 to traverse vertically in the chamber 10, then a second blowing system 40 and a second heating system 50 can be provided directly opposite the first system 40, 50. Such a configuration is shown in FIG. 8.

The curing temperature of the dye on/in the web 2 is, preferably, within a small range. Therefore, if the motion of the web 2 stops for any reason (for example, failure of the web feeding device, breaking of the web), the portion of the web 2 inside the chamber 10 could be damaged. To prevent such an occurrence from happening, a controller 80 is provided. The controller 80 can be electronic, such a microprocessor, or it can be entirely analog, or a combination of both. The controller 80 has a plurality of control and/or read lines connected to each part of the system 1 so that control signals can be sent thereto and read signals can be received therefrom. The controller 80 is programmed to carry out the control functions described herein.

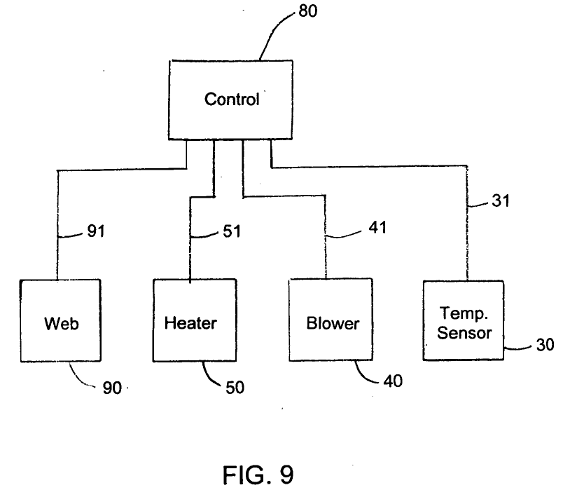

An exemplary simplified control circuit is shown in FIG. 9. A temperature read line 31 is connected from the controller 80 to the temperature sensor 30 for receiving the temperature read by the sensor 30. A blower control line 41 is connected from the controller 80 to the blower system 40 for controlling the speed and/or condition (on/off) of the blower system 40. A heater control line 51 is connected from the controller 80 to the heating system 50 for controlling the level (temperature) and/or condition (on/off) of the heating system 50. Finally, a web status line 91 is connected to a web status system 90 (indicated only diagrammatically in FIG. 9) for indicating a status of the web 2. This web status system 90 indicates to the controller 80 any condition of the web 2 other than the web 2 being in its proper movement speed. If the web 2 breaks, slows down, etc. or the operator stops the web 2 for any reason, then the web status system 90 sends a signal to the controller 80 to enter a fail-safe mode. In the fail-safe mode, the controller 80 causes the heating system 50 to lower (e.g., cool) to a reduced safety level at temperature substantially below the curing temperature and causes the blower system 40 to go into an increased blowing mode (in particular, a full-speed blowing mode)—making the heated air at the curing temperature exit the chamber 10 in a time frame that prevents damage to the non-moving material web 2. The reduced safety level temperature is not so low to require a delay in movement of the web 2 until the curing chamber heats up to the curing temperature when the web 2 restarts. Because of the fail-safe mode, once the restart order arrives at the controller 80, the reaction time of the heating system 40 is quick enough to come back to the curing and heat-setting temperature within a few seconds, preferably, 2 to 5 seconds. Thus, the web 2 can start moving at the same time the fail-safe mode ends and returns to the normal operating mode. It is noted that the lines 31, 41, 51, 91 can be uni-directional or bi-directional for two-way communication of information.

The controller 80 is also connected to the power on/power off switch of the system 1 to indicate that the power off status is not a signal to enter the fail-safe mode. However, the power off status can cause the heating system 50 to turn off and the blower system 40 to turn on for a limited time (e.g., one minute) to cool off the chamber 10 and evacuate all heated air from the chamber 10 and into the chimney 70.

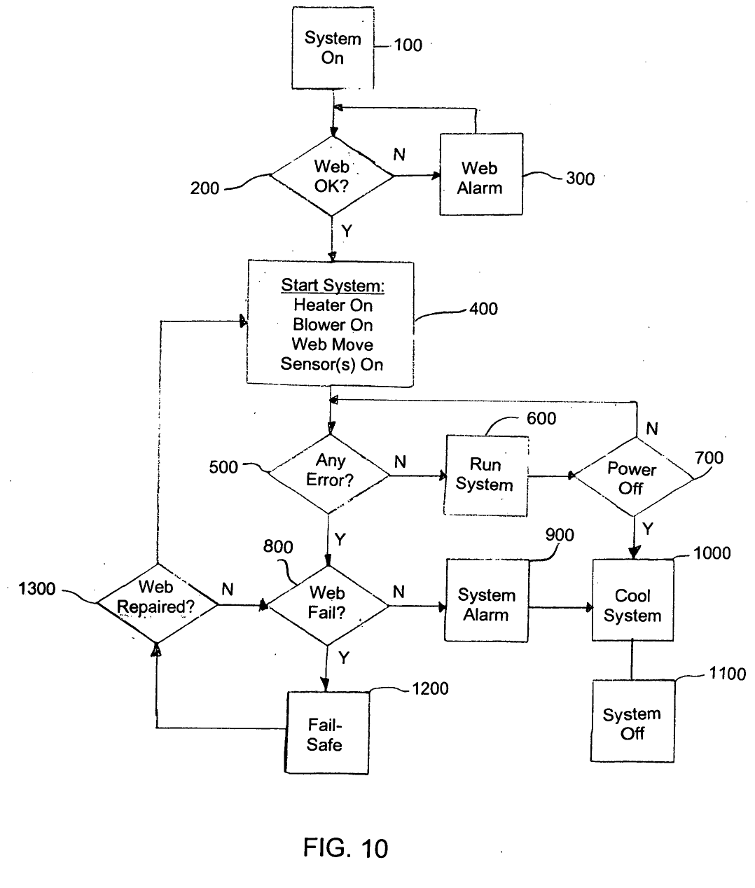

The flow chart of FIG. 10 indicates the method of operating the system 1.

In Step 100, the system 1 is powered on.

In Step 200, a query is made to determine whether or not the web 2 is ready to be processed. The controller 80 receives information from the web movement system 90 or from the operator (e.g., by a switch) that the web 2 is installed properly and is ready for traveling through and processing by the system 1. For example, the third device 24 can have a tension-determining device that measures whether or not the web 2 is being pulled by the third device 24. The tension-determining device can be and integral part of the third device 24 and can measure the speed of the third device 24 or the load acting upon the third device 24.

If the web 2 is not ready for any reason, in Step 300, an alarm sounds (audio and/or visual) and the operator must fix the web 2 before the system 1 will start.

If the web 2 is ready, then, in Step 400, the sub-systems, including at least the sensor(s) 30, the blower system 40, the heating system 50, and the web movement system 90, are started.

After starting the sub-systems, in Step 500, the controller 80 receives information from all of the devices 20, 30, 40, 50, 60, 70, 90 of the system 1 (periodically or continuously) and determines whether or not any aspect of the system 1 is non-functional.

If all sub-systems are functioning in a predefined way, then, in Step 600, the system 1 begins processing the printed web 2 and continues to do so until, in Step 700, the operator powers off the system 1 or until an error is detected in Step 500.

If the system 1 is powered off, the controller 80 causes the system 1 to go into a turn-off mode in Step 1000. In the turn-off mode, the heater system 50 turns off and the blower system 40 turns on, preferably, to an increased blowing mode (in particular, a full-speed blowing mode). Thus, the blower system 40 cools the system 1. After a predetermined period of time, e.g., one minute, the system 1 shuts off in Step 1100. Cooling off with the blower system 40 is optional, in other words, it is not a requirement.

If any sub-system does not give the “OK” upon start or if an error is detected after running of the system 1, then, in Step 800, a query is made to determine whether or not the web 2 has failed in some way. If the answer is no, then, in Step 900 a system alarm occurs (audio and/or visual), indicating to the operator that some aspect of the system 1 is not functioning. The controller 80 can be provided with a display in which information is displayed to the user, in particular, which sub-system has the fault. The display can be in the form of a speaker and/or a set of LEDs associated with text printed next to each of the LEDs or it can be some kind display screen (e.g., LCD).

Simultaneously with the system alarm (or shortly thereafter), the controller 80 causes the system 1 to go into a shutdown mode in Step 1000. In the shutdown mode, the heater system 50 turns off and the blower system 40 turns on, preferably, to an increased blowing mode (in particular, a full-speed blowing mode). Thus, the blower system 40 cools the system 1. Regardless of the status of the blower system 40 and/or the heater system 50, all aspects of the system 1 are turned off, except for the error indicator at the controller 80. Until the error is corrected, the system 1 stays in the shutdown mode so that, in particular, the blower system 40 and the heater system 50 cannot cause injury to a repairperson working to fix the system 1. After fixing the system 1, the operator can restart the system 1 in Step 100.

If, in Step 800, the error is merely a failure of the web 2, then the system 1 goes into the fail-safe mode in Step 1200. As described above, in the fail-safe mode, the controller 80 causes the heating system 50 to lower (i.e., cool) to a reduced safety level at temperature substantially below the curing temperature and also causes the blower system 40 to go into an increased blowing mode (in particular, a full-speed blowing mode)—making the heated air at the curing temperature exit the chamber 10 in a time frame that prevents damage to the non-moving material web 2. The reduced safety level temperature is not so low to require a delay in movement of the web 2 upon restart.

When the web 2 is repaired and the controller 80 receives an indication, in Step 1300, that the system 1 can return to its normal operating mode (Step 600), the system 1 restarts in Step 400. Because the fail-safe mode keeps the heating system 50 on (albeit at a reduced level), and due to the fact that the heating system 50 reaction time returns to its curing and heat-setting temperature within a few seconds, e.g., 2 to 5 seconds, the web 2 starts moving at the same time the restart order arrives at the controller 80 and the fail-safe mode ends. In other words, the return to the normal operating mode in Step 600 is virtually instantaneous in terms of the web curing time.

FIG. 2 shows some other features of the system 1. First, the chamber 10 can be provided with threaded inserts 18 for mounting the chamber 10 on a surface. Second, a hinged heatshielding door 11 can be provided on one or both of the sides of the chamber 10 next to each of the edges of the web 2. A heatshield can be used to prevent the heat in the chamber 10 from being transmitted to the sides of the chamber 10 and, thereby, present a burn hazard to the operator. Such a heatshield can take any form and, in one form, merely can be insulation on either side of the edges of the web 12.

A label that is produce according to the method and system of the present invention has a substantially increased definition of the printed indicia (is more legible), virtually eliminates bleeding, and lasts longer when exposed to industrial washing processes.

Although the present invention has been described in terms of certain specific embodiments, it is understood that various changes and modifications may be made without departing from the present invention, and reference should be made to the appended claims to determine the proper scope of this invention.

We claim:

1. A system for curing dye at a material web, comprising:
a curing chamber defining:
an interior for receiving the web of material therein;
an entrance connecting said interior with the environment and receiving the web therethrough in a first direction; and
an exit connecting said interior with the environment and transmitting the web therethrough from said interior to said environment in a second direction;
a temperature sensor disposed at said curing chamber for sensing a temperature of the web;
a heating system disposed at said chamber and heating air inside said chamber; and
an air transfer system disposed at said chamber and circulating air in said interior of said chamber, said air transfer system and said heating system, when activated, heating the web in said interior to a substantially constant curing temperature.

2. The system according to claim 1, further comprising:
a first web-direction-changing device disposed at said chamber altering a movement direction of the web from said first direction to a third direction; and
a second web-direction-changing device disposed at said chamber altering a movement direction of the web from said third direction to a fourth direction.

3. The system according to claim 2, further comprising a third web-direction-changing device disposed at said chamber altering a movement direction of the web from said third direction to said second direction.

4. The system according to claim 2, further comprising a third web-direction-changing device disposed at said chamber for altering a movement direction of the web from said third direction to a fourth direction.

5. The system according to claim 4, wherein:
said chamber has a bottom surface;
said first direction is parallel to said bottom surface;
said second direction is parallel to said bottom surface;
said third direction is at an angle to said bottom surface; and
said fourth direction is at an angle to said bottom surface.

6. The system according to claim 1, wherein said first direction and said second direction are substantially parallel.

7. The system according to claim 1, wherein said first direction and said second direction are collinear.

8. The system according to claim 5, wherein:
said first and second directions are substantially parallel to ground; and
said third and fourth directions are substantially vertical.

9. The system according to claim 1, wherein:
said chamber has a bottom and a top;
said entrance and said exit are at said bottom of said chamber;
a web guide is disposed at said top of said chamber for guiding the web from said bottom upward in an approximately vertical direction entirely through said chamber and approximately reverse the course of the web downward in an approximately vertical direction entirely through said chamber to exit said chamber from said bottom; and
said temperature sensor is disposed at said top of said chamber.

10. The system according to claim 1, wherein said temperature sensor is an infrared temperature sensor.

11. The system according to claim 1, further comprising a second temperature sensor disposed at said exit and measuring a temperature of the web exiting said chamber.

12. The system according to claim 1, wherein said chamber has a door that, when opened, permits a user to access the web inside said chamber.

13. The system according to claim 1, further comprising a web cutter/stacker system disposed downstream of said chamber for cutting the web into individual labels and stacking the cut labels.

14. The system according to claim 1, wherein:
said chamber has at least one air inlet side; and
said air transfer system is a blower directing environmental air into said air inlet side of said chamber in an air blowing direction.

15. The system according to claim 14, wherein said heating system is disposed between the web and said blower.

16. The system according to claim 14, wherein said heating system is disposed downstream of said blower in said air blowing direction.

17. The system according to claim 1, wherein said chamber has a top defining an opening allowing heat in said chamber to escape.

18. The system according to claim 17, wherein said top has a chimney carrying away heated air from said chamber.

19. The system according to claim 18, wherein said chamber has a roof pitched to place said chimney at an upper-most portion thereof.

20. The system according to claim 18, wherein said chimney defines a window accommodating therein said temperature sensor.

21. The system according to claim 1, wherein said heating system has a heater element and a heat shield disposed opposite said heater element on an opposite side of the web and one of:
reflecting heat back to said heating system; and
absorbing heat from said heating system
to regulate temperature of air in said interior of said chamber.

22. The system according to claim 1, further comprising a second blowing system and a second heating system on a side of the web opposite said heating system and said blowing system.

23. The system according to claim 1, further comprising a controller programmed to detect changes in motion of the web.

24. The system according to claim 23, wherein said controller has at least one of control and read lines connected to at least one of said temperature sensor, said heating system, said air transfer system, the web, and a web control system to transmit control signals thereto and read signals therefrom.

25. The system according to claim 24, said controller controls said heating and air transfer systems to maintain a temperature inside said chamber between approximately 200° F. and approximately 390° F.

26. The system according to claim 1, wherein the web is a web for clothing labels and the dye in each label indicates at least one of washing instructions and data of a garment on which a respective one of the labels is attached.

27. The system according to claim 1, wherein the dye is resin ink printed on the web and said chamber, said heating system, and said air transfer system cure the resin ink on the web.

28. A system for curing dye at a material web, comprising:
a curing chamber:
defining an interior for receiving the web of material therein; and
having a top and a bottom, said bottom defining:
an entrance connecting said interior with the environment and receiving the web therethrough in an approximately vertical direction; and
an exit connecting said interior with the environment and transmitting the web therethrough from said interior to said environment in an approximately vertical direction;
a temperature sensor disposed at said top of said chamber for sensing a temperature of the web;
a heating system disposed at said chamber and heating air inside said chamber;
an air transfer system disposed at said chamber and circulating air heated by said heating system in said interior of said chamber, said air transfer system and said heating system, when activated, heating the web in said interior to a substantially constant curing temperature; and
said temperature sensor, said heating system, and said air transfer system being fixed in position relative to said chamber.

29. A method for curing dye at a material web, which comprises:
providing a material web having a dye printed thereat;
passing the web through a dye-curing chamber upwards in an approximately vertical direction;
heating an interior of the chamber to a dye-curing temperature;
measuring a temperature of the heated web at a top of the chamber; and
passing the heated web back through the chamber downwards in an approximately vertical direction to cure the dye in the web.
